(19) United States
(12) Patent Application Publication
(10) Pub. No.: US 2022/0172415 A1
(43) Pub. Date: Jun. 2, 2022

(54) EVENT ORCHESTRATION FOR VIRTUAL EVENTS

(71) Applicants: AT&T Intellectual Property I, L.P., Atlanta, GA (US); AT&T Mobility II LLC, Atlanta, GA (US)

(72) Inventors: John Oetting, Zionsville, PA (US); Eric Zavesky, Austin, TX (US); Terrel Lecesne, Round Rock, TX (US); James H. Pratt, Round Rock, TX (US); Jason Decuir, Cedar Park, TX (US)

(21) Appl. No.: 17/106,038

(22) Filed: Nov. 27, 2020

(51) Int. Cl. G06T 11/60

(52) U.S. Cl. CPC G06T 11/60

(57) ABSTRACT

In one example, a method includes presenting a virtual event to a plurality of user endpoint devices associated with a plurality of participants, receiving, while the virtual event is in progress, a first signal from a first user endpoint device, wherein the first signal indicates that a first participant wishes to join the virtual event, admitting the first participant to the virtual event, and selecting, from among a plurality of candidate locations, a first location in the virtual event in which to place the first participant.

The present disclosure relates generally to virtual media, and relates more particularly to devices, non-transitory computer-readable media, and methods for orchestrating virtual events.

### BACKGROUND

More and more events that were once hosted strictly in person are now being modified to be hosted virtually (or to at least include an option for participants to join the events virtually). These events include things like business meetings, club meetings, fitness classes, elementary, high school, college, and continuing education classes, music lessons, and the like. These events may also include events on a larger scale, such as concerts, plays, professional conferences, political rallies and conventions, media conventions, film screenings and festivals, and the like.

### SUMMARY

In one example, a method performed by a processing system including at least one processor includes presenting a virtual event to a plurality of user endpoint devices associated with a plurality of participants, receiving, while the virtual event is in progress, a first signal from a first user endpoint device, wherein the first signal indicates that a first participant wishes to join the virtual event, admitting the first participant to the virtual event, and selecting, from among a plurality of candidate locations, a first location in the virtual event in which to place the first participant.

In another example, a non-transitory computer-readable medium stores instructions which, when executed by a processing system in a telecommunications network, cause the processing system to perform operations. The operations include presenting a virtual event to a plurality of user endpoint devices associated with a plurality of participants, receiving, while the virtual event is in progress, a first signal from a first user endpoint device, wherein the first signal indicates that a first participant wishes to join the virtual event, admitting the first participant to the virtual event, and selecting, from among a plurality of candidate locations, a first location in the virtual event in which to place the first participant.

In another example, a device includes a processor and a computer-readable medium storing instructions which, when executed by the processor, cause the processor to perform operations. The operations include presenting a virtual event to a plurality of user endpoint devices associated with a plurality of participants, receiving, while the virtual event is in progress, a first signal from a first user endpoint device, wherein the first signal indicates that a first participant wishes to join the virtual event, admitting the first participant to the virtual event, and selecting, from among a plurality of candidate locations, a first location in the virtual event in which to place the first participant.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for orchestrating virtual events, in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides methods, computer-readable media, and apparatuses for orchestrating virtual events. As discussed above, more and more events that were once hosted strictly in person are now being modified to be hosted virtually (or to at least include an option for participants to join the events virtually). These events include things like business meetings, club meetings, fitness classes, elementary, high school, college, and continuing education classes, music lessons, and the like. These events may also include events on a larger scale, such as concerts, plays, professional conferences, political rallies and conventions, media conventions, film screenings and festivals, and the like.

Some virtual events are even rendered as immersive experiences, to more closely simulate the experience of being at a “real” event. For instance, video and audio may be rendered using an immersive display to make a participant feel as if he is actually present at a concert, rather than simply watching a concert on his television. Although the technology used to support virtual events has improved dramatically in a short period of time, there are certain aspects of the in-person experience that existing technology has failed to adequately translate to the virtual realm. For instance, the placement of participants (e.g., the rooms, sections, views, or the like to which participants are assigned) tends to be haphazard and often requires human intervention and/or a preassigned ticketing system to properly accommodate all participants. In addition, as with in-person events, other participants may interfere with a given participant's enjoyment of the event. For instance, other participants may be talking loudly, obstructing the view, or the like. However, it may be more difficult to alert an event organizer to the interference when the event is virtual. In addition, the virtual environment often makes it difficult for participants to interact in a natural way (e.g., to mingle with others, explore the virtual space, etc.).

Examples of the present disclosure facilitate orchestration of virtual events by providing a virtual “usher” component to acclimate participants to the virtual event space and mediate the participants' experiences within the virtual event space. In one example, the virtual usher may be presented as an avatar or simulated human form who can allow and encourage movement of participants throughout the virtual space (e.g., to other virtual rooms, sections, or the like). In a further example, the virtual space may be divided into distinct rooms, sections, or the like, within which groups of participants may gather to participate in the virtual event. Further examples of the present disclosure may monitor the virtual event for behavioral cues that can guide grouping of participants. For instance, participants who share similar behaviors (e.g., dancing or singing along during a concert) can be grouped together, or participants exhibiting anomalous behavior (e.g., interfering with the enjoyment of other participants) can be isolated.

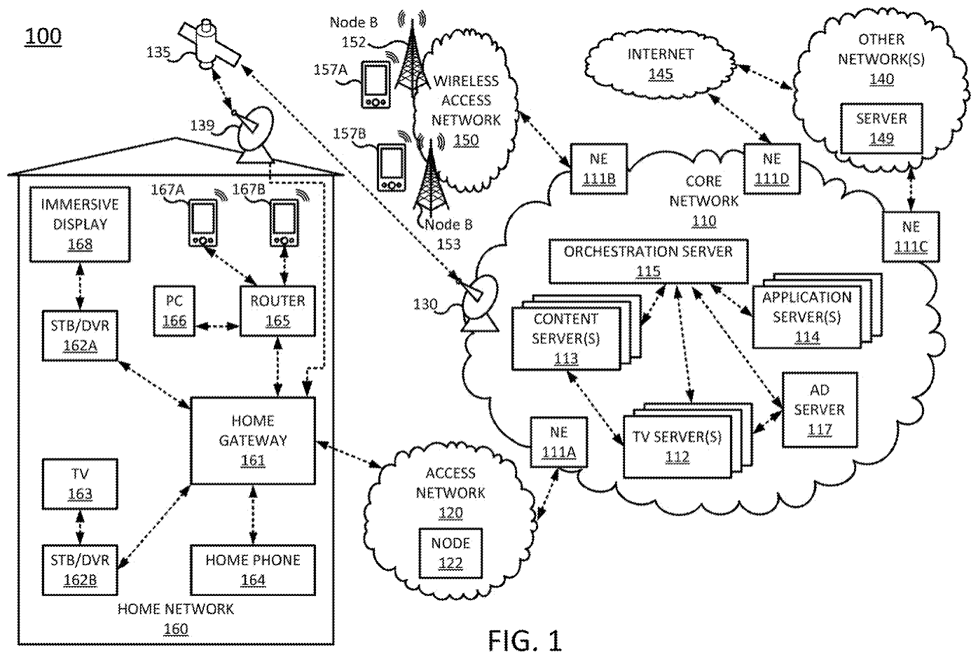

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163, home phone 164, router 165, personal computer (PC) 166, immersive display 168, and so forth, with one another and with various other devices via a core network 110, a wireless access network 150 (e.g., a cellular network), an access network 120, other networks 140 and/or the Internet 145. In some examples, not all of the mobile devices and home network devices will be utilized in orchestrating virtual events. For instance, in some examples, orchestrating virtual events may make use of the home network devices (e.g., immersive display 168 and/or STB/DVR 162A), and may potentially also make use of any co-located mobile devices (e.g., mobile devices 167A and 167B), but may not make use of any mobile devices that are not co-located with the home network devices (e.g., mobile devices 157A and 157B).

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an orchestration server 115 (e.g., an application server). For ease of illustration, various additional elements of core network 110 are omitted from FIG. 1.

In one example, orchestration server 115 may generate content streams that, when rendered on one or more user endpoint devices (e.g., mobile devices 157A, 157B, 167A and 167B, and home network devices such as set-top boxes (STBs) 162A, and 162B, television (TV) 163, personal computer (PC) 166, immersive display 168, and so forth) present a virtual, potentially immersive event. For instance, the virtual event may be a concert, a conference, a convention, an educational presentation, a tour, a theatrical performance, or the like. The virtual event may be rendered in a manner that simulates the experience of being present at a “real” event. For instance, the rendering of the virtual event may include a representation of an event venue or space including various different sections or sub-spaces. The rendering of the virtual event may also include representations of other participants (e.g., avatars), which may be rendered to look, move, sound, and behave in manners that mimic the corresponding participants.

In some examples, the orchestration server 115 may additionally render a virtual “usher” for the virtual event. The virtual usher may comprise an invisible component or feature of the virtual event, or may be embodied in a virtual representation or avatar that looks like a human usher. The virtual usher may help a participant who is joining a virtual event to select a location from which to participate in the virtual event. For instance, the virtual usher may access a profile associated with the participant in order to determine the participant's interests and preferences (e.g., prefers to sit during concerts, speaks Spanish as a first language, frequently attends virtual events with children, etc.). Based on the participant's interests and preferences, the virtual usher may locate a group of like-minded participants who the participant could join. The group of like-minded participants could be gathered in a designated location within the virtual event space, where the designated location may impose certain restrictions on participant behavior within the location (e.g., no swearing, no advertisements for alcoholic beverages, dancing permitted, etc.). In another example, the virtual usher may locate friends or family members of the joining participant and direct the participant to a location in which the friends or family members are gathered.

Throughout the virtual event, the virtual usher may monitor the behavior of the participants within a location to verify that the behavior conforms to any restrictions imposed within the location and/or to verify that the participants appear to be comfortable in the location (e.g., no other participants are interfering with their enjoyment of the virtual event). In one example the orchestration server 115 may collect data provided by user endpoint devices of the participants. The collected data may be provided directly to the orchestration server 115 by the user endpoint devices, e.g., via the mobile devices 157A, 157B, 167A, and 167B, the PC 166, the home phone 164, the TV 163, and/or the immersive display 168. This collected data may help the orchestration server 115 to monitor participant behavior.

Profiles for the participants could be retrieved from network storage, e.g., application servers 114, by the orchestration server 115. For instance the collected data may comprise user profiles maintained by a network service (e.g., an Internet service provider, a streaming media service, a gaming subscription, etc.), portions of social media profiles maintained by a social media web site (e.g., a social networking site, a blogging site, a photo-sharing site, etc.), and the like. The profile for a participant may indicate the participant's name (e.g., real name or alias), age (or age range), location (e.g., city and state, country, etc.), previous virtual events attended, contacts (e.g., other participants who the participant may know, such as friends and family members), and preferences (e.g., preferred seating locations at specific virtual venues, preferred immersion settings, preferred activities or level of participation in virtual events, etc.). The orchestration server 115 may also have access to third party data sources (e.g., server 149 in other network 140), where the third party data sources may store the profiles.

In some cases, the virtual usher may move a participant to another location, or may modify the location, in order to improve the participant's comfort or another participant's comfort. For instance, video processing techniques could be employed to remove obstructions (e.g., including other participants) from a participant's line of sight. Audio processing techniques could be employed to mute other participants whose conversations may be distracting or to amplify audio the participant wants to hear (e.g., a concert or presentation). In some cases, a participant may simply be moved to another location where different participants are present. Thus, the orchestration server 115, via the virtual usher, may be able to provide a personalized experience within the virtual event. The ability to personalize a participant's experience of a virtual event may make the virtual event more like (and, in some cases, may even be an improvement on) a “real” event.

The orchestration server 115 may interact with television servers 112, content servers 113, and/or advertising server 117, to select content for rendering to present a virtual, potentially immersive event. For instance, the content servers 113 may store scheduled or pre-recorded event content such as pre-recorded concerts, conferences, educational presentations, theatrical productions, and so forth. Alternatively, or in addition, content providers may stream various contents to the core network for distribution to various subscribers, e.g., for live content, such as news programming, sporting events, concerts, conferences, educational presentations, theatrical productions, and the like. In one example, advertising server 117 stores a number of advertisements that can be selected for presentation to users, e.g., in the home network 160 and at other downstream viewing locations. For example, advertisers may upload various advertising content to the core network 110 to be distributed to various users during virtual events. Any of the content stored by the television servers 112, content servers 113, and/or advertising server 117 may be used to generate computer-generated content which, when presented alone or in combination with pre-recorded or real-world content or footage, produces a virtual, potentially immersive event.

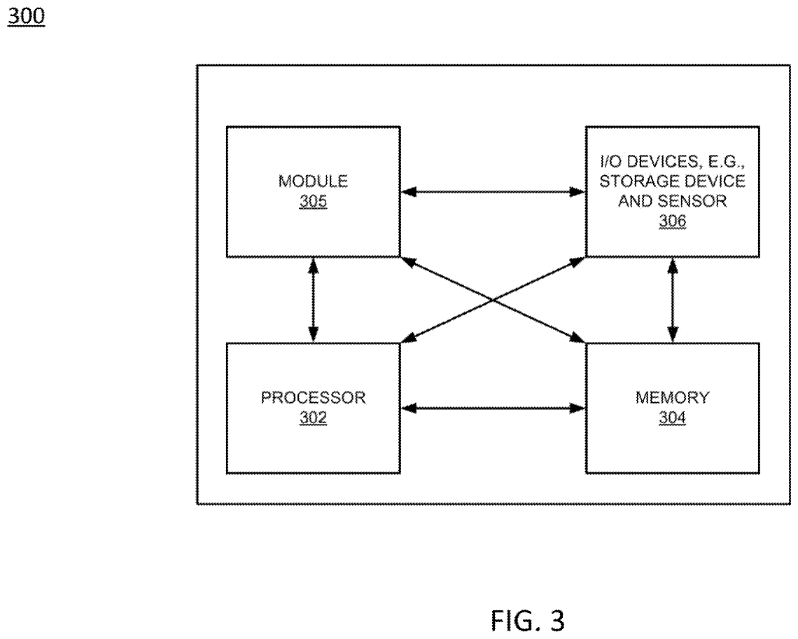

In one example, any or all of the television servers 112, content servers 113, application servers 114, orchestration server 115, and advertising server 117 may comprise a computing system, such as computing system 300 depicted in FIG. 3.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television or event content from television servers 112 for uplink transmission to satellite 135. Accordingly, satellite 135 may receive television content from ground station 130 and may broadcast the television or event content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163 and/or immersive display 168 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, and so forth. In one example, router 165 may further communicate with TV (broadly a display) 163 and/or immersive display 168, e.g., where one or both of the television and the immersive display incorporate “smart” features. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163 and/or immersive display 168, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

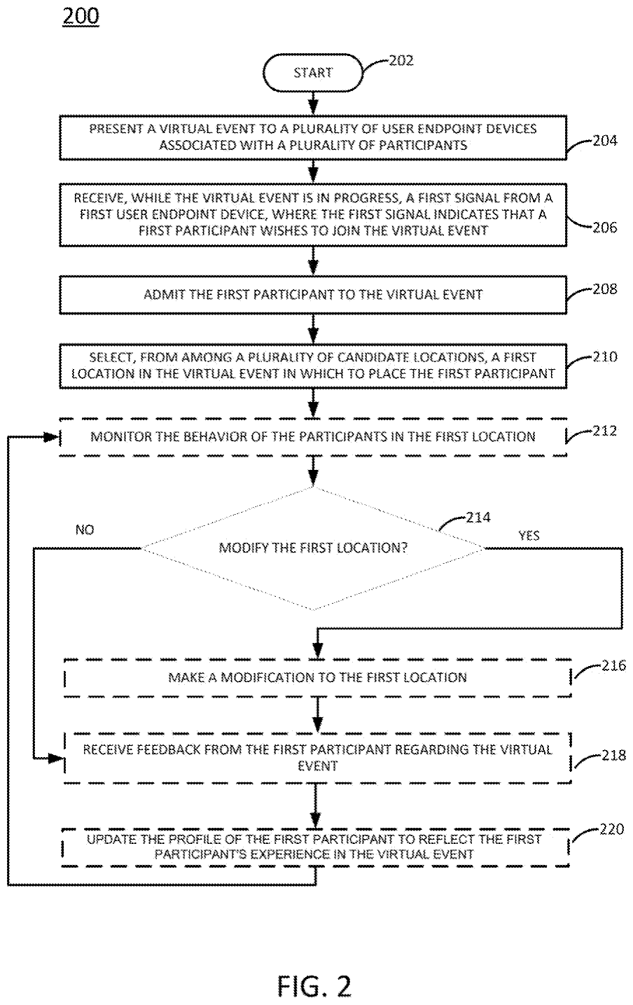

To further aid in understanding the present disclosure, FIG. 2 illustrates a flowchart of a method 200 for orchestrating virtual events, in accordance with the present disclosure. In one example, the method 200 may be performed by an orchestration server that is configured to facilitate orchestration of a virtual event, such as the orchestration server 115 illustrated in FIG. 1. However, in other examples, the method 200 may be performed by another device, such as the processor 302 of the system 300 illustrated in FIG. 3.

The method 200 begins in step 202. In step 204, the processing system may present a virtual event to a plurality of user endpoint devices associated with a plurality of participants. In one example, the virtual event may be an immersive event in which an extended reality (XR) environment is rendered to simulate the experience of being at a real-world event, such as a concert, a conference, a movie theater, a tour, or the like. In one example, the plurality of user endpoint devices may include one or more of: an immersive display, a mobile phone, a computing device, or any other devices that are capable of rendering an XR environment.

In one example, presenting the virtual event may comprise rendering a virtual venue for the virtual event (e.g., a conference room, an arena, a sports stadium, a theater, or the like), where the virtual venue may be divided into a plurality of discrete locations as described in further detail below. In a further example, presenting the virtual event may also comprise rendering virtual representations or avatars of the participants of the event. The participants may be able to control the appearances of their avatars, and, depending upon the technology used by the participants to join the virtual event (e.g., whether the participants have access to technology that can track movements), the avatars may even mimic the movements and gestures of the participants in the virtual event. For instance, if a participant waves his left arm in the “real world,” the participant's avatar may wave his left arm in the space of the virtual event.

In one example, presenting the virtual event may include loading or initializing one or more applications for use by participants of the virtual event. For instance, if the virtual event is a professional conference, presenting the virtual event may include initializing one or more breakout rooms for smaller meetings; if the virtual event is a training event, presenting the virtual event may include initializing one or more training simulations and evaluation tools; if the virtual event is a concert, presenting the virtual event may include initializing one or more tools through which the participants can provide feedback that can be experienced by other participants (e.g., cheering, singing along, etc.).

In step 206, the processing system may receive, while the virtual event is in progress, a first signal from a first user endpoint device (e.g., which may not be one of the plurality of user devices to which the virtual event is already being presented), where the first signal indicates that a first participant (e.g., a user of the first user endpoint device) wishes to join the virtual event. In this case, “in progress” does not necessarily imply that the main portion of the virtual event has begun, but only that participants have the ability to join or log into the virtual event. For instance, the virtual event may include a period of time during which the participants may “arrive” and get settled in the virtual space while waiting for the virtual event to commence. As an example, if the virtual event is a concert, this period of time may be similar to the “doors open” time before the concert begins. The participants may use this period of time to log in, find their location from which they are going to participate, adjust the settings of their user endpoint devices, and the like, before the band begins their performance.

In step 208, the processing system may admit the first participant to the virtual event. In one example, admitting the first participant to the virtual event may include delivering one or more streams of audio and visual (and optionally additional modalities) content to the first user endpoint device, so that the virtual event can be rendered for the first participant. In one example, the first user endpoint device and/or the first participant may be authenticated to the virtual event before the streams of audio and visual data are delivered to the first user endpoint device. For instance, the processing system may verify that the first user endpoint device and/or the first participant is authorized to join the virtual event (e.g., similar to a ticketing process at a “real” event). The first user endpoint device may be required to provide a password, a pin number, a ticket code, or the like to be authenticated to the virtual event. Alternatively, the processing system may verify that an IP address or other identifiers associated with the first user endpoint device match an IP address or other identifiers of the first user endpoint device that has been authorized to join the virtual event.

In one example, admitting the first participant to the virtual event may additionally involve retrieving a profile for the first participant. For instance, the processing system may have access to a database that stores profiles for virtual event participants. A profile for a participant may include information about the participant, including, for example, the participant's name (real name or alias), age (or age range), location (e.g., city and state, country, etc.), previous virtual events attended, contacts (e.g., other participants who the participant may know, such as friends and family members), interests (e.g., hobbies, favorite musicians or movies, favorite sports teams, etc.), and preferences (e.g., preferred seating locations at specific virtual venues, preferred immersion settings, preferred activities or level of participation in virtual events, etc.).

In step 210, the processing system may select, from among a plurality of candidate locations, a first location in the virtual event in which to place the first participant. In one example, the selection of the first location may be based at least in part on the first participant's profile. For instance, as discussed above, the first participant's profile may indicate the first participant's preferences with respect to participation in virtual events. As an example, if the first participant's profile indicates that she likes to dance at concerts, and the virtual event is a concert, then the processing system may select a first location for the first participant that includes other participants who like to dance at concerts. Alternatively, if the first participant prefers to sit in her seat at concerts, and the virtual event is a concert, then the processing system may select a first location for the first participant in which other participants are sitting (e.g., not standing, dancing, or the like). In further examples, the processing system may select a first location in which one or more friends or family members of the first participant are located. In further examples, the processing system may select a first location in which other participants are experiencing the same degree of network latency as the first participant.

Within the context of the present disclosure, a “location” in a virtual event may be understood to refer to a subset of the participants in the virtual event for whom the same (or substantially the same) experience is rendered. For instance, the actions of any participant in a given location may be experienced by other participants in the given location. As an example, if a participant in the given location speaks, the other participants in the given location may be able to hear him speak (while participants in other locations may not be able to hear him speak). If a participant in the given location waves his arms, the other participants in the given location may be able to see him wave his arms (while participants in other locations may not be able to see him wave his arms). Thus, although all participants may share certain universal portions of the virtual event experience (e.g., all participants may be able to see and hear the band during a virtual concert), the more localized experience of the virtual event may differ depending upon the location from which a participant experiences the virtual event (e.g., some participants may be dancing in a crowd near the stage, other participants may be sitting in their seats in the mezzanine, etc.). Thus participants in the virtual event may simultaneously experience the virtual event in ways that may differ to different degrees.

In one example, the virtual event may be separated into a plurality of discrete locations or zones in which participants may be placed. In one example, the locations may be arranged such that they are fully or partially visible to each other. For instance, a virtual arena that is set up for a concert could be separated into a plurality of different locations that are arranged in a circle around a stage. A participant who is placed in a first location at the end of the stage may be able to see the other locations (including adjacent locations, locations on the other end of the stage, and the like), and may even be able to move freely between the locations in some cases. This may help to simulate the feeling of being at a “real” concert. However, as discussed above, the participant may not be able to clearly see or hear participants who are located in the other locations while he is in the first location.

In another example, different locations may be associated with different access policies that may govern the behavior of participants in those locations. For instance, a “family friendly” location may require that participants refrain from swearing, while a “21 and up” location may require that participants be at least 21 years old; a “quiet” location may require that participants refrain from talking on their phones or talking loudly; a “premium” or “VIP” location may require that participants pay an additional fee for access; an “accessible” location may include enhancements for participants who may require some form of assistant (e.g., closed captioning for participants who have hearing impairments); a “Spanish language” location (broadly a foreign language location) may be designated for participants who speak Spanish; and the like.

In optional step 212 (illustrated in phantom), the processing system may monitor the behavior of the participants in the first location (e.g., a subset of the plurality of participants). For instance, the processing system may perform audio processing techniques in order to monitor the audio associated with the first location. The audio processing techniques may include speech recognition processing and sentiment analysis, which may help the processing system to recognize words being spoken and sentiments being expressed by the words (e.g., “This is my favorite song,” versus “I wish that girl would stop waving her arms”). The processing system could also perform image processing techniques in order to monitor the visuals associated with the first location. The image processing techniques may include object recognition processing, facial recognition processing, and object tracking, which may help the processing system to detect and recognize people and things in the first location, as well as actions being performed by the people and things (e.g., determining when an object or person is obstructing a view of the stage, when a participant is making a face that appears to express annoyance or boredom, etc.).

In a further example, the processing system may also monitor for any messages that the first user endpoint device has submitted to the processing system on behalf of the first participant. For instance, the first participant may send a text message to the processing system implicitly or explicitly requesting the processing system to take some action (e.g., “Please move me to another location,” “I can't hear anything over this guy shouting,” etc.). Sentiment analysis, keyword extraction, and other text processing techniques could be used to understand the nature of the request.

In optional step 214 (illustrated in phantom), the processing system may determine whether to modify the first location, based on the monitoring. For instance, the processing system may compare events detected in the first location (such as actions, utterances, and the like that have been detected as described above) to the preferences of the first participant in order to determine whether a modification to the first location would better align the first location with the preferences of the first participant (and therefore, ideally, improve the first participant's enjoyment of the virtual event). For instance, if the first participant's profile indicates that she prefers to sit during concerts, and the other participants in the first location begin dancing (thereby potentially obstructing the first participant's view of the stage), then the processing system may determine that a modification to the first location should be made. Similarly, if the processing system detects the first participant making a face that appears to express annoyance, stating that another participant is making it hard for her to hear the band, or sends a text message to the processing system asking to be moved to another location, then the processing system may determine that a modification to the first location should be made.

In another example, the processing system may be configured to modify the locations of participants at a certain time. For example, mirroring the timeline of an in-person conference, all participants at a first time instance may be located to ideally watch a keynote address. Subsequently, all participants at a second time instance may be located to socialize, review individual presentations, or inspect virtual booths that are included as part of the conference. In this example, the decision to modify the first location in step 214 may be driven either by the user's behavior in step 212, a predetermined schedule and placement within the virtual event at step 210, or a combination of both. In an additional example, a predetermined schedule and placement may be at odds (e.g., where the first participant is demonstrating strong engagement with one or more other participants at the first location, but the event is scheduled to move all participants to a second location). In this situation, the processing system may assign a priority, provide an interactive notification and option, or simply ignore the request to modify the first location in step 214 of one or more participants.

If the processing system determines in step 214 that a modification to the first location should not be made, then the method may proceed directly to optional step 218, described in further detail below. If, however, the processing system determines in step 214 that a modification to the first location should be made, then the method may proceed to optional step 216.

In optional step 216 (illustrated in phantom), the processing system may make a modification to the first location. As discussed above, the modification may be a modification that improves the alignment of the first location with the preferences of the first participant. In one example, the modification may involve moving the first participant to a second location in the virtual event that is different from the first location, where the second location may be determined to be better aligned with the preferences of the first participant. For instance, if the first participant's profile indicates that she prefers to sit during concerts, and the other participants in the first location begin dancing (thereby potentially obstructing the first participant's view of the stage), then the processing system may move the first participant to a second location in which the participants are sitting.

In another example, the modification may involve sending a message to at least one other participant in the first location, where the message may ask the at least one other participant to take some action. For instance, if the first participant's profile indicates that she prefers to sit during concerts, and a second participant in the first location begins dancing (thereby potentially obstructing the first participant's view of the stage), then the processing system may send a message to the second participant asking the second participant if she would mind sitting down. The message could be a text-based message, and audio message, or another type of message that is sent to the user endpoint device that the second participant is using to participate in the virtual event (e.g., so that the message is directed only to the second participant and not to any other participants in the first location).

In another example, the modification may involve removing an element of the first location. For instance, if the first participant's profile indicates that she prefers to sit during concerts, and a second participant in the first location begins dancing (thereby potentially obstructing the first participant's view of the stage), then the processing system may perform image processing in order to digitally remove the second participant from the first participant's view. Similarly, if the second participant is talking loudly, the processing system may be able to perform audio processing to mute the second participant's audio or otherwise filter out the second participant's audio in the streams that are being delivered to the first user endpoint device.

In another example, the removing of the element of the first location may involve moving the element to a second location, different from the first location. For instance, if a second participant is swearing loudly, and the first location is designated as a “family friendly” location, then the processing system may move the second participant to a second location where swearing may be permitted. In one example, moving the second participant to the second location may alter the rendering of the first location for all participants who are not the second participant (e.g., so that the second participant does not appear in the first location to these other participants). However, the processing system may continue to render the first location for the second participant in order to make it appear to the second participant that he is still in the first location. This approach may help to address the behavior of participants who may intentionally be interfering with the enjoyment of other participants. For instance, some participants may enjoy trying to agitate others. By removing these participants without signaling to these participants that they are being removed, further conflicts can potentially be avoided (e.g., complaints and/or further agitation by the removed participants can be minimized). In one example, if the second participant's behavior violates a participant code of conduct for the virtual event, the second participant may be removed from the virtual event altogether (i.e., without being moved to a second location).

In another example, the removing of the element of the first location may be temporary or partial. For instance, a first participant may be a parent of a second participant, and the first and second participants may be in locations specifically designated for adults and children, respectively. The first participant may wish to occasionally visit or view the second participant in her second location, but not with a full avatar representation. In this example, the audio and visual elements of the first location would be replaced by elements of the second location and be presented to the first participant (the parent). However, the second participant (the child) would not receive any audio or video elements from the parent of the first location, and the second participant's experience and location would be unchanged. Following this temporary movement to the second location, the first participant would return to the first location and correspondingly receive the elements of the first location after a set amount of time or an explicit interaction with the processing system.

In optional step 218 (illustrated in phantom), the processing system may receive feedback from the first participant regarding the virtual event. In one example, the feedback may comprise explicit feedback. For instance, the first participant may provide a review or rating (e.g., x stars out of y) to indicate the first participant's satisfaction with the virtual event or with a particular action taken by the processing system. For instance, after making a modification to the first location, the processing system may present a dialog to the first participant inquiring whether the modification has improved the first participant's experience. The first participant may respond with a yes/no answer, a rating, a thumbs up or down, or the like). In another example, the feedback may be more implicit. For instance, after the processor has modified the first location, the first participant may be observed saying, “That's better,” or smiling.

In optional step 220 (illustrated in phantom), the processing system may update the profile of the first participant to reflect the first participant's experience in the virtual event. For instance, if the first participant spent most of the virtual event in a “quiet” location, the profile for the first participant could be updated to indicate a possible preference for locations in which loud talking is prohibited. Similarly, if the first participant spent five minutes in a location where participants were dancing, and then moved to a different location where participants were sitting for the rest of the virtual event, the profile for the first participant could be updated to indicate a possible preference for “sitting” locations over “dancing” locations. If the first participant complained about the behavior of a second participant, the profile of the first participant could be updated to indicate that the first participant should not be placed in the same location as the second participant during future virtual events.

The method 200 may then return to step 212, and the processing system may continue to monitor the behavior of the participants in the first location (or the second location, if a modification involved moving the first participant to a second location) as described above. Thus, the processing system may continuously monitor a first participant's experience in a virtual event, and may make modifications to the first participant's experience when necessary so that the experience is better aligned with the first participant's preferences. In this way, the virtual event may be made to feel more like a “real” event. In some examples, the virtual event may even improve upon real events by providing a real-time mechanism for removing elements of the virtual event that may be interfering with the first participant's enjoyment of the virtual event, or finding like-minded other participants with whom the first participant can enjoy the virtual event together.

In further examples, the operations of the method 200 could be embodied in the form of a virtual “usher” who assists the first participant in moving among locations during the virtual event. The virtual usher may be presented as a human (or human-like) avatar, where the appearance of the avatar could be configured by the first participant (thus, each participant could have their own, customized virtual usher). In further examples, the virtual usher could be sponsored by an advertiser, thereby providing a unique avenue for advertising that allows direct interaction with a participant.

In some examples, the use of multiple discrete locations within a virtual event may also provide better opportunities for advertisers and sponsors to present content to event participants. For instance, if the virtual event includes a “family friendly” location, then advertisements may be presented in designated areas of the location that relate to children's products and services (e.g., toys, educational applications, children's clothing, etc.). If the virtual event includes a “21 and up” location, then advertisements for alcoholic beverages may be presented in designated areas of the location. If the virtual event is a concert that includes a “premium” or “VIP” location, then advertisements for band merchandise may be presented in designated areas of the location (since participants who are willing to pay more for a better location may also be more likely to be hardcore fans who are interested in merchandise). Thus, the advertising content that is presented in a location of the virtual event could be targeted to the subset of participants who are expected to be present in the location.

Thus, examples of the present disclosure may provide mechanisms for improving the orchestration of various types of virtual events. For instance, in one example, the mechanisms described herein could be used to orchestrate a live conference. For instance, a participant in a virtual conference could be watching a two-dimensional or three-dimensional (e.g., XR) presentation as a member of the audience. Audio emanating from other members of the audience could be muted during the presentation, without muting the audio of the person who is giving the presentation. In another example, while watching a live presentation, audio emanating from a first participant may be only audible for other participants who have a social connection to the first participant (e.g., friends, family members, employees) or whose profiles indicate a preference for hearing adjacent participants. In this example, all other second participants would have the audio from the first participant muted.

In another example, the mechanisms described herein could be used to orchestrate a virtual networking event. For instance, when a participant joins the event, other participants who the participant may already know could be located. Alternatively, if the participant does not known any of the other participants, other groups of participants with whom the participant shares common interests could be located. Privacy settings could also be implemented to prevent other participants from eavesdropping on or inadvertently overhearing conversations. In further examples, different cues (e.g., visible cues, audible cues, etc.) could be presented to participants to encourage more socializing and mingling.

In another example, the method 200 may be utilized to usher a first participant to one or more locations at an event. In this example, the first participant may be the singer, comedian, or politician that the event was created to showcase in a corresponding concert, comedy special, or campaign rally. In this case, the processing system may help the first participant to locations containing different groups of other participants sequentially first, second, third, and so-on, according either to a fixed schedule (e.g., appointments established for one or more groups of participants) or in an ad-hoc manner (e.g., the first participant has indicated through feedback in step 218 of the method 200 that she has spent enough time in the current location). In either of these scenarios, the processing system may orchestrate the movement of one or more participants as defined by the method 200.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a server (such as might be used to perform the method 200) could be implemented as illustrated in FIG. 3.

As depicted in FIG. 3, the system 300 comprises a hardware processor element 302, a memory 304, a module 305 for orchestrating virtual events, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for orchestrating virtual events may include circuitry and/or logic for performing special purpose functions relating to the operation of a home gateway or AR server. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for orchestrating virtual events (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for orchestrating virtual events (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
presenting, by a processing system including at least one processor, a virtual event to a plurality of user endpoint devices associated with a plurality of participants;
receiving, by the processing system while the virtual event is in progress, a first signal from a first user endpoint device, wherein the first signal indicates that a first participant wishes to join the virtual event;
admitting, by the processing system, the first participant to the virtual event; and
selecting, by the processing system from among a plurality of candidate locations, a first location in the virtual event in which to place the first participant.

2. The method of claim 1, wherein the presenting the virtual event comprises:
rendering, by the processing system, a virtual representation of a venue of the virtual event, wherein the venue is divided into the plurality of candidate locations; and
rendering, by the processing system, the virtual representation to the plurality of participants of the virtual event.

3. The method of claim 1, wherein the admitting comprises:
retrieving, by the processing system a profile for the first participant, wherein the profile specifies at least one selected from a group of: a name of the first participant, an age of the first participant, a real location of the first participant, a previous virtual event attended by the first participant, a contact of the first participant, an interest of the first participant, and a preference of the first participant.

4. The method of claim 3, wherein the selecting is based at least in part on the profile for the first participant.

5. The method of claim 4, wherein the first location comprises a location that is aligned with the preference of the first participant.

6. The method of claim 4, wherein the first location is a location at which the contact of the first participant is present.

7. The method of claim 1, further comprising:
monitoring, by the processing system, behavior of a subset of the plurality of participants that is present in the first location; and
modifying, by the processing system, the first location in response to the behavior and to a preference of the first participant.

8. The method of claim 7, wherein the modifying comprises moving the first participant to a second location of the plurality of candidate locations that is different from the first location.

9. The method of claim 7, wherein the modifying comprises sending a request to a second participant of the subset of the plurality of participants, wherein the request asks the second participant to take an action.

10. The method of claim 7, wherein the modifying comprises removing an element of the first location on the first user endpoint device.

11. The method of claim 10, wherein the element comprises a virtual representation of a second participant of the subset of the plurality of participants.

12. The method of claim 11, wherein the virtual representation of the second participant is moved to a second location of the plurality of candidate locations that is different from the first location.

13. The method of claim 10, wherein the element comprises audio of a second participant of the subset of the plurality of participants.

14. The method of claim 10, wherein the element comprises a virtual representation of an object.

15. The method of claim 1, further comprising:
receiving, by the processing system, feedback from the first participant regarding the virtual event; and
updating, by the processing system, a profile of the first participant based on the feedback.

16. The method of claim 1, wherein at least some locations of the plurality of candidate locations are tailored for different sets of interests.

17. The method of claim 1, wherein at least some locations of the plurality of candidate locations impose restrictions on behavior within the at least some locations.

18. The method of claim 1, wherein at least some locations of the plurality of candidate locations impose access policies that restrict who can access the at least some locations.

19. A non-transitory computer-readable medium storing instructions which, when executed by a processing system in a telecommunications network, cause the processing system to perform operations, the operations comprising:
presenting a virtual event to a plurality of user endpoint devices associated with a plurality of participants;
receiving, while the virtual event is in progress, a first signal from a first user endpoint device, wherein the first signal indicates that a first participant wishes to join the virtual event;
admitting the first participant to the virtual event; and
selecting, from among a plurality of candidate locations, a first location in the virtual event in which to place the first participant.

20. A device comprising:
a processor; and
a computer-readable medium storing instructions which, when executed by the processor, cause the processor to perform operations, the operations comprising:
presenting a virtual event to a plurality of user endpoint devices associated with a plurality of participants;
receiving, while the virtual event is in progress, a first signal from a first user endpoint device, wherein the first signal indicates that a first participant wishes to join the virtual event;
admitting the first participant to the virtual event; and
selecting, from among a plurality of candidate locations, a first location in the virtual event in which to place the first participant.
